(19) United States
(12) Patent Application Publication
(10) Pub. No.: US 2004/0200781 A1
(43) Pub. Date: Oct. 14, 2004

(54) Gutter to hose coupling device for rain water diversion

(76) Inventors: Kathryn L. Shaw, Nederland, CO (US); Michael W. Shaw, Nederland, CO (US)

Correspondence Address: Kathryn L. Shaw, P.O. Box 1175, Nederland, CO, 80466, US

(21) Appl. No.: 10/410,217

(22) Filed: Apr. 8, 2003

(51) Int. Cl. B01D 27/00; E04D 13/04

(52) U.S. Cl. 210/747; 210/446; 52/12; 210/162; 210/459

(57) ABSTRACT

A simple coupling device which diverts water from a gutter to a garden hose, comprising a gutter sleeve, water channel and threaded hose connector. Excess water is expelled through an overflow outlet which also allows for filter screen access and debris removal.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. This invention relates to passive rain distribution from an existing gutter system through a gutter to hose coupling device.

2. Background of the Invention

Many parts of the country are experiencing a terrible drought. Many communities have water use restrictions. Therefore, we searched for affordable rain diverter products that would function with existing gutter systems. We needed a product that would function on sloping lots and that would allow us to attach a hose to the bottom of a gutter. We did not want a water storage feature due to the problems associated with winter freezing. There is a ban on standing water in many areas because of problems from mosquito born diseases.

There are several barrel type systems available. U.S. Pat. No. Des. 326,705 to Vanden burg (1992) provides a storage tank with no gutter or hose attachments. U.S. Pat. No. Des. 335,744 to Small (1993) provides a storage tank with no hose attachment. Barrel type systems do not work on sloping lots without requiring significant modification of the existing gutter system and landscape which could negatively effect the drainage around the foundation. Barrel type systems limit the amount of rain water that can be harvested due to the storage tank size. Barrel types need to be drained to prevent freezing in the winter. Water storage units pose problems associated with mosquito born diseases. They could detract from the design of the home and landscape.

There are “non-barrel”0 diverter systems. U.S. Pat. No. 5,114,594 to Rosebrock (1991) requires gutter reconfiguration, features inner and outer ducts to regulate water flow and collection and does not include a threaded hose attachment. U.K. Patent GB 2 249 338 A to Yates (1991) requires gutter reconfiguration, provides water collection, but does not include a threaded hose attachment, nor an overflow outlet with an easy access for cleaning, nor a filter screen for filtering debris.

All of the rain diverter devices heretofore known suffer from a number of disadvantages:

(a) Many units contain water storage features which are not compatible with freezing temperatures and are banned in certain areas due to mosquito born diseases.

(b) They require reconfiguration of the gutter system and do not simply attach to the end of the existing gutter system.

(c) Do not provide a simple coupling device which connects a hose to a gutter.

(d) Barrel types are not compatible with sloping lots and may detract visually.

(e) Do not offer a combination of a gutter to hose coupling, an overflow outlet, a filter screen and a flexible design which conforms to existing gutter designs.

### BACKGROUND OF INVENTION-OBJECTS AND ADVANTAGES

Accordingly, there are many advantages to our invention. The benefits of our invention are:

(a) to provide a simple coupling device with the means of attaching a garden hose to a residential gutter system;

(b) to provide passive irrigation with rain water;

(c) to provide an easy to clean out feature through the built in overflow outlet;

(d) to provide a filter screen to keep debris from clogging the hose;

(e) to provide an adaptable gutter sleeve to accommodate several gutter designs;

(f) to provide a one piece molded plastic coupling with a filter hose washer and attachment screws;

(g) to provide a threaded garden hose attachment for passive irrigation needs;

(h) to provide an overflow outlet which protects gutter systems during heavy rains;

(i.) to provide a rain diverter which can be used on sloping lots, in small yards or where bushes or other permanent landscape features already exist;

(j.) to provide an affordable rain water delivery system which saves on water bills;

(k) to provide property owners who have restricted water use a means to irrigate trees and gardens;

(l) to provide an easy to install device for use by home owners, landscapers, gardeners, rental property owners, gutter installers, city or county governments, parks, etc.

(m) to provide a rain diverter that will not freeze in winter;

(n) to provide a rain diverter that will avoid problems associated with standing water.

Still further objects and advantages will become apparent from a consideration of the ensuing description and drawings.

### SUMMARY

This simple invention offers an affordable and user friendly alternative to previous rain collector and diverter systems. It will deliver rainwater that funnels down the gutter system to a hose for landscape irrigation every time it rains. This one piece lightweight unit is designed to be a small coupling device at the bottom of a downspout which connects to the existing gutter with screws. It features an overflow outlet which prevents gutter system damage during severe rains and also allows easy access for cleaning. There is a screen in the unit to prevent clogging of the hose. A garden hose is simply attached to the threaded end of the coupling for use in drip irrigation, deep watering, soaker hose use, etc.

### DRAWINGS—FIGURES

FIG. 1 shows the top view of the wide orientation of the fully assembled coupling unit with scored lines for overflow outlet cut out.

FIG. 2 shows the bottom view of the wide orientation of the fully assembled coupling unit which does not have an overflow outlet option.

FIG. 3 shows the top view of the narrow orientation of the fully assembled coupling unit with scored lines for overflow outlet cut out.

FIG. 4 shows the bottom view of the narrow orientation which does not have an overflow outlet option.

FIG. 5 shows the front view of the coupling unit.

FIG. 6 shows the rear view of the coupling unit.

FIG. 7 is a view showing the overflow outlet after the scored lines have been cut and the plastic removed on the wide version.

FIG. 8 shows an expanded side view of the face plate, filter hose washer holding ridge, filter hose washer, and threaded hose attachment.

FIG. 9 shows the overflow outlet after the scored lines have been cut for the narrow application.

FIG. 10 shows typical application

### DRAWINGS—REFERENCE NUMERALS

1. threaded hose attachment

2. face plate

3. raised ridge to hold filter hose washer

4. filter hose washer

5. location of top overflow and cleaning access outlet

6. scored lines to be cut by consumer to create overflow outlet on top of the wide version of the unit. 6a is for flat application; 6bis is for vertical application

7. sleeve for male end of existing gutter placement

8. sleeve for female end of existing gutter placement

9. screw hole dents which facilitate screwing unit to the existing gutter

10. back of unit which is hollow and is slipped over existing gutter

11. scored lines to be cut by consumer to create overflow outlet on top of the narrow orientation of the unit

12. attachment screws

13. coupler unit

### DETAILED DESCRIPTION—PREFERRED EMBODIMENT

This object is made to fit over common 2″×3″ gutter. It is made of polypropylene plastic in one piece. A 1″ filter hose washer 4 and ½″ screws 12 for attachment are included with the coupling unit. The inlet 10 size is to accommodate both the female size 8; 3.25″×2.25″ or male size 7; 3″×2″ of gutter. This allows this product to be used on either female or male end of pipe provided. Screw hole dents 9 are provided for marking and drilling of holes to attach the unit to the existing gutter elbow or pipe. Scored lines 6 are provided in the coupler unit for overflow cut outs. This unit can be used in both flat or vertical alignment. The owner is to cutout the proper side of the coupler to match his application. Next the 1″ washer screen 4 is inserted into the raised ridge 3. The raised ridge3 is on the face plate 2 on the inside of the unit. The ¾″ threaded hose attachment 1 is on the outer face, inline with the hole in the face plate.

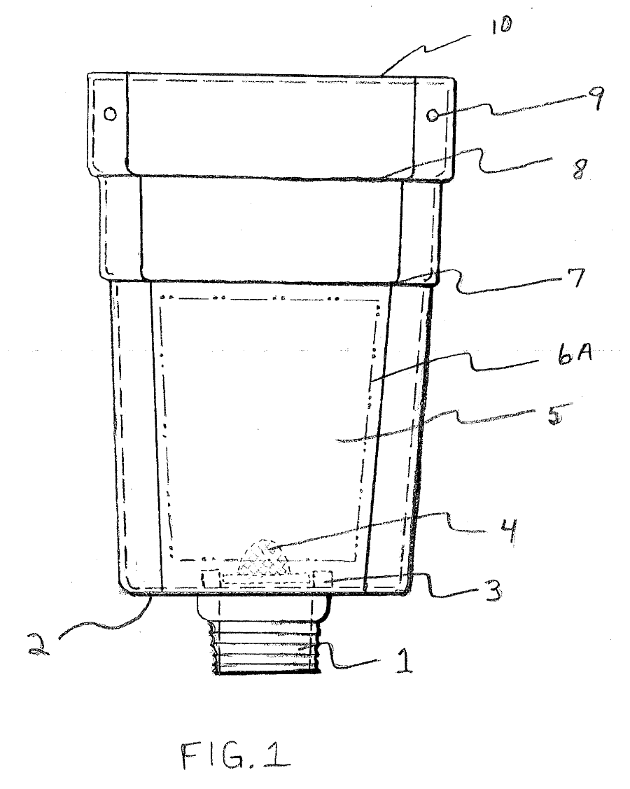

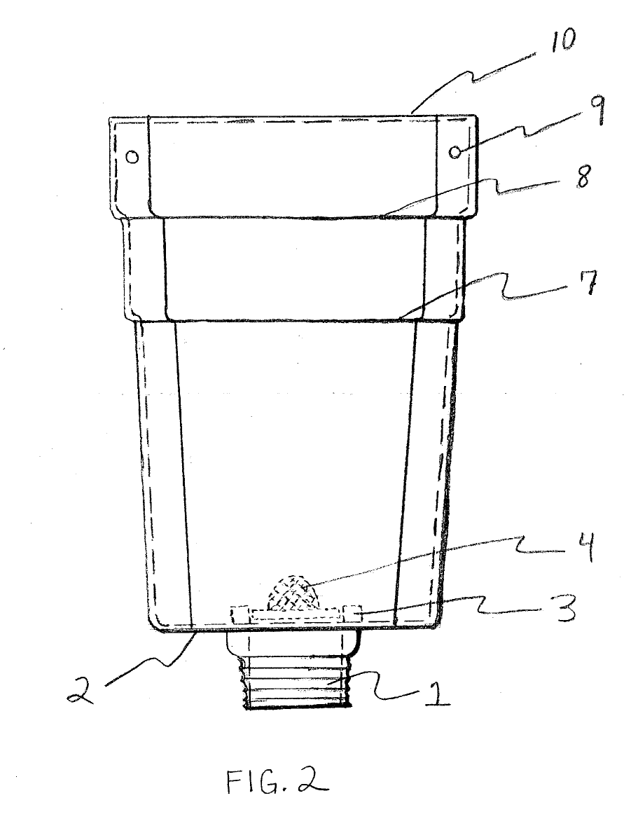

Operation—FIGS. 1, 3, 7, 9

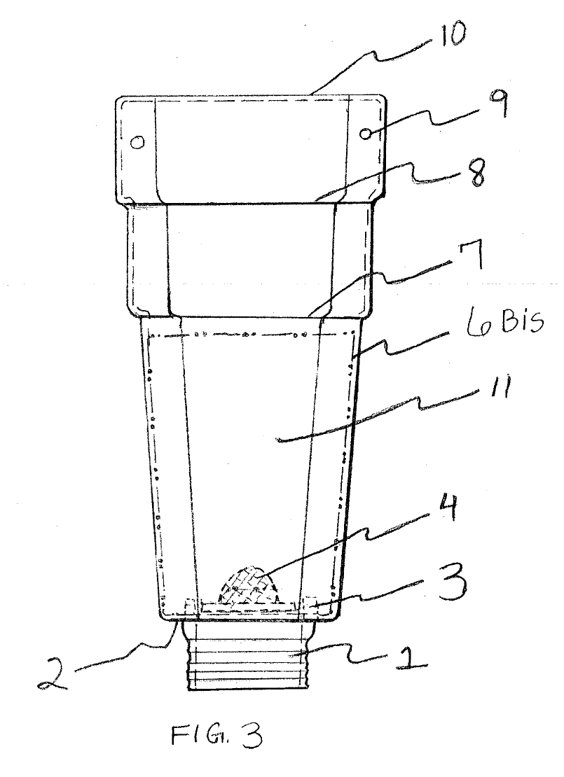

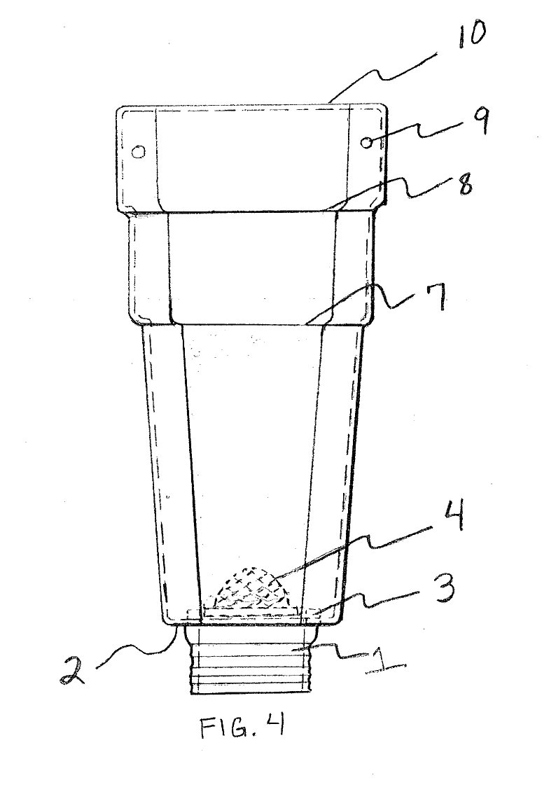

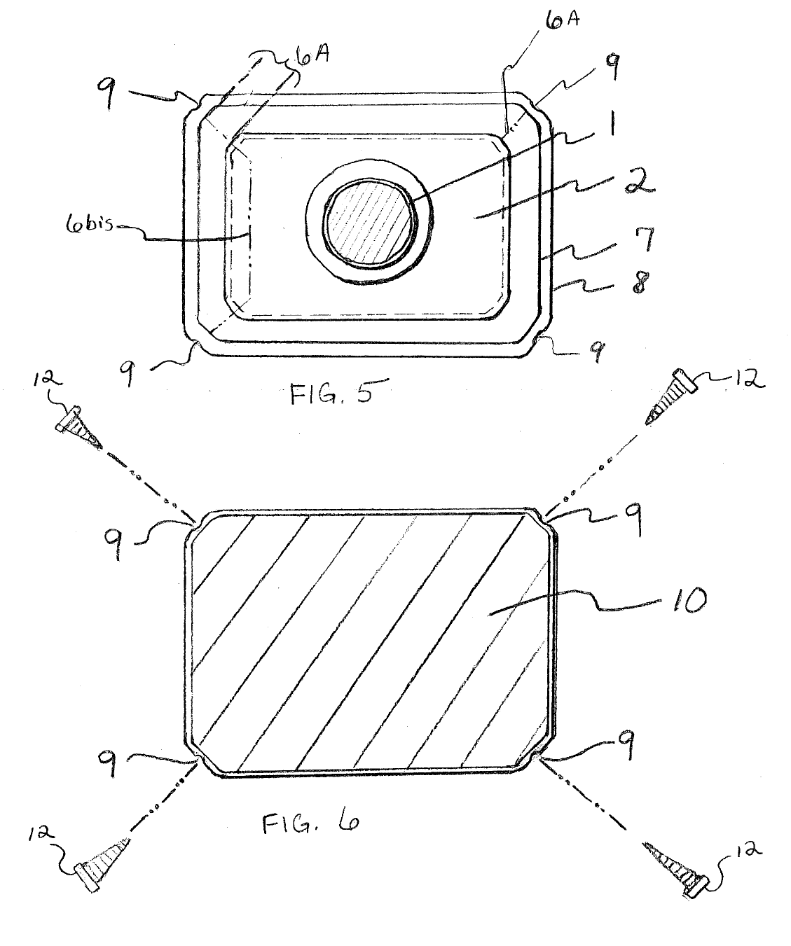

The manner of using the rain diverter coupling device is as follows. First the user needs to determine if the top of the gutter elbow that they have at the end of the rectangular downspout on their home is wide or narrow. This dictates the orientation of the said coupler. The two available choices are illustrated in FIG. 1 for the wide orientation top view or FIG. 3 for the narrow orientation top view. The owner then is to cut out the appropriate scored side to create the overflow and easy cleanout feature. These lines, 6a and 6bis are scored for easy and proper cutting.

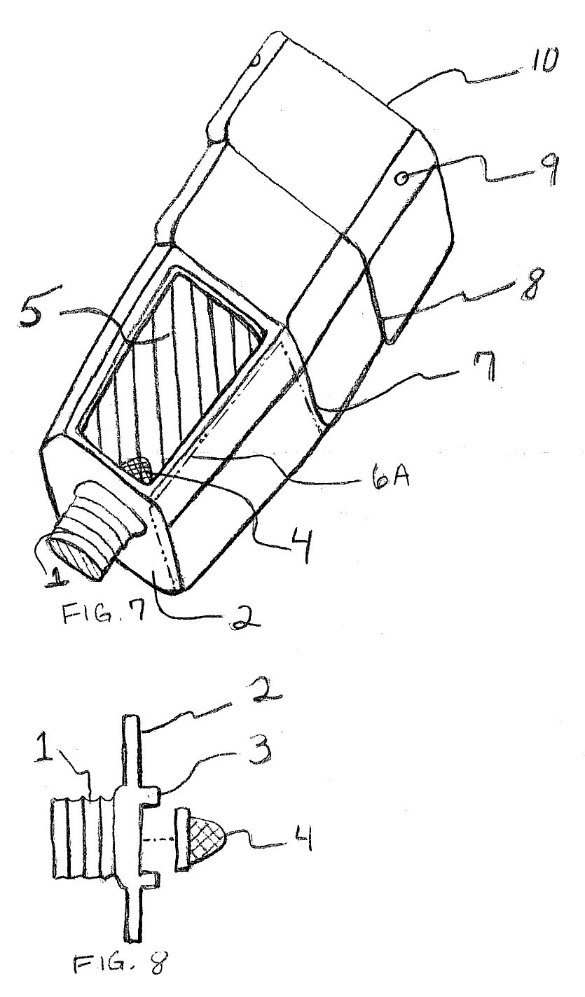

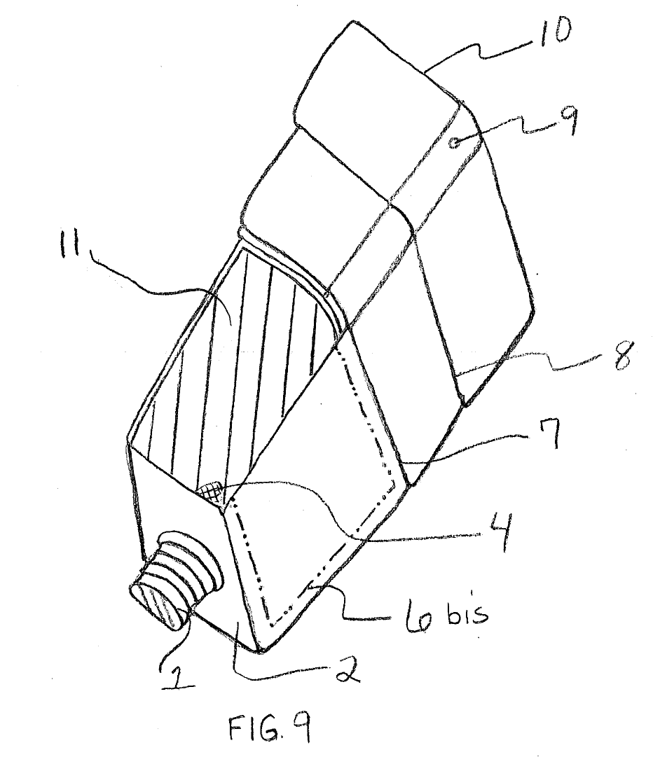

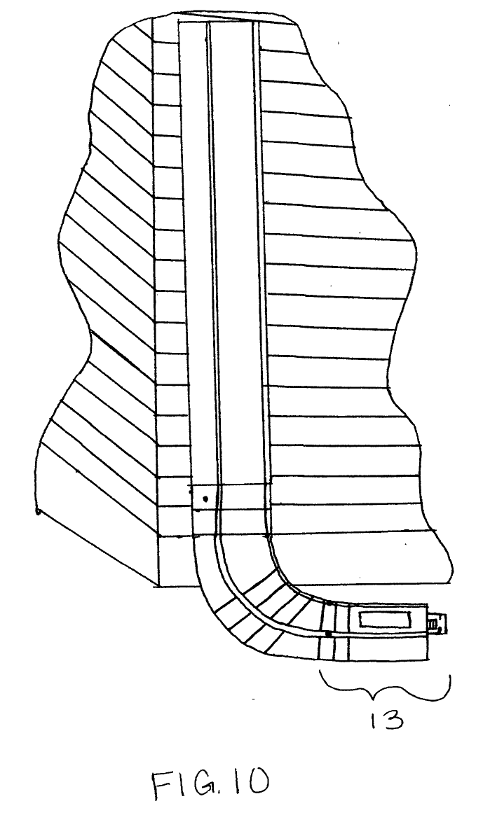

This area 5 in FIG. 7 and FIG. 9 is to be removed. Next the owner is to slide the coupler on the existing gutter downspout until it fits tight. Then a drill is to be used to drill through screw hole dents 9 in the coupler and the elbow or pipe of the existing downspout. Provided screws 12 are then screwed into these holes and tightened to complete attachment. Next the enclosed washer screen 4 is placed in the raised ridge 3. Finally the owner attaches his garden hose to the threaded end 1 and the hose is placed wherever the owner needs watering.

Advantages

From the description above a number of advantages becomes evident.

(a) This is a simple one piece coupling unit that can easily be attached to the elbow or pipe at the discharge end of a residential gutter system.

(b) This coupling unit attaches a garden hose to a gutter.

(c) This unit will work whenever it rains.

(d) It is ideal for sloping lots, small yards and similar conditions.

(e) An overflow outlet protects gutter systems during heavy rains.

(f) Water from the gutter is filtered before it enters the hose.

(g) This coupling unit can deliver a substantial amount of rain from a roof.

The following calculation is based on 1″ of rain. The average roof size is 2500 sq. ft. for a home and garage. Approximately 15% will be lost due to evaporation and the initial wetting of the roof. The calculation is as follows:

2500 SF×1″ rain=360,000 cubic inches of water

1 gallon=231 cubic inches of water

360,000/231=1558 gallons

1558×85%=1325 gallons per 1″ of rain

This gives you approximately 24 fifty-five gallon drums of water to divert every time we receive 1″ of rain. Most homes have 4 down spouts. Each downspout would yield an average of 6 fifty-five gallon drums of water per 1″ of rain.

(h) There are no restrictions as to quantity collected as there us no tank involved.

(g) The points of watering can be changed by moving the watering hose to various landscape locations.

(h) May provide the only available water to distant areas of the landscape where watering restrictions are in place or if the home is on a well. (In most areas well water cannot be used for irrigation by law.)

(j) Does not visually impair the landscape due to its small unobtrusive size.

(k) Is easy to clean via the overflow outlet.

(l) It is affordable, lightweight and easy to install.

(m) Has no water storage unit which can present problems with freezing and can act as a breeding ground for mosquitoes.

Conclusion, Ramifications and Scope

Accordingly, the reader will see that the rain diverter can be used for irrigation easily and conveniently. It is a simple and inexpensive method for distributing rain water to the landscape. This product is particularly helpful during drought conditions and will contribute to saving valuable trees, shrubs and gardens.

Although the description above contains many specificities, these should not be construed as limiting the scope of the invention but as merely providing illustrations of some of the presently preferred embodiments of this invention. For example, this product can be modified to accommodate different gutter and downspout profiles. The rain diverter coupling unit could have a variety of attractive shapes and colors. The coupling unit could be made of different kinds of plastic, metals, clay, etc. It could be used without the overflow and filter hose screen options.

Thus the scope of the invention should be determined by the appended claims and their legal equivalents, rather than by the examples given.

We claim:

1. An irrigation device having the means for connecting a hose to a gutter, comprising:
(a) a coupling unit which channels water from a gutter system to a hose
(b) a threaded hose attachment
(c) a hollow channel for water passage
(d) a sleeve that slides over said gutter to be secured with fasteners,
whereby said irrigation coupling unit contains means for channeling water from said gutter through said hollow channel to said hose connector.

2. The irrigation device of claim 1 wherein said irrigation device includes an overflow outlet with the means for allowing excess water to flow out of said hollow channel and said outlet provides an open cavity for cleaning access.

3. The irrigation device of claim 1 wherein said irrigation device includes a filter with the means for restricting debris from entering the hose.

4. The irrigation device of claim 1 wherein said coupling unit includes said overflow outlet and said filter.

5. The irrigation device of claim 1 wherein said coupling unit is composed of plastic.

6. The irrigation device of claim 1 wherein said coupling unit is composed of metal.

7. The irrigation device of claim 1 wherein said coupling unit is composed of a combination of plastic and metal.

8. The irrigation device of claim 1 wherein said unit is colored.

9. A coupling method of channeling water from a gutter to a hose, comprising:
(a) providing a sleeve and fasteners for connecting said coupling unit to said gutter
(b) providing a threaded connector for said hose
(c) providing water passage through a hollow coupling whereby water is channeled from said gutter through said hollow coupling to said hose connector.

10. The method of claim 10 wherein said coupling includes a filter for restricting debris from entering the hose.

11. The method of claim 10 wherein said coupling includes said overflow outlet for discharging and cleaning and said filter for restricting debris from entering said hose.

12. The method of claim 10 wherein said coupling unit is composed of plastic.

13. The method of claim 10 wherein said coupling unit is composed of metal.

14. The method of claim 10 wherein said coupling unit is composed of a combination of plastic and metal.

15. The method of claim 10 wherein said coupling unit is colored.
